(19) United States
(12) Patent Application Publication
(10) Pub. No.: US 2006/0223896 A1
(43) Pub. Date: Oct. 5, 2006

(54) Method for the recovery of a vinyl alcohol polymer in solution

(75) Inventors: Jean-Christophe Lepers, Ottignies (BE); Hervé Gazio, Brussels (BE)

Correspondence Address: CONNOLLY BOVE LODGE & HUTZ, LLP, P O BOX 2207, WILMINGTON, DE, 19899, US

(73) Assignee: Inergy Automotive Systems Research (Societe Anonyme), Brussels (BE)

(21) Appl. No.: 10/549,099

(22) PCT Filed: Mar. 11, 2004
(86) PCT No.: PCT/EP04/02634

§ 371 Date: Oct. 14, 2005

(30) Foreign Application Priority Data
Mar. 14, 2003 (FR) 03/03209

(51) Int. Cl. C08J 11/04

(52) U.S. Cl. 521/46.5

(57) ABSTRACT

Process for recovering a vinyl alcohol polymer in solution in a solvent, according to which: (a) the polymer solution is converted into a gel (b) water is added to the gel obtained (c) the gel is broken mechanically to form polymer particles suspended in a liquid comprising the solvent and water. Particles obtained according to this process and multilayer fuel tank comprising in the barrier layer the EVOH obtained via this process.

The present invention relates to a process for recovering a vinyl alcohol polymer in solution, and also to particles of vinyl alcohol polymer that may be obtained via this process.

Vinyl alcohol polymers are abundantly used in industries such as textiles, adhesives, packaging, papermaking, etc., in which their excellent resistance to solvents and to fats, and also their adhesive and barrier properties, are appreciated. However, these polymers have the particular feature of being soluble in water, which is a drawback for many applications (especially in the presence of moisture) but, on the other hand, is an advantage from the point of view of their recycling via solvent means, since sparingly polluting or non-polluting aqueous solutions may be used for this purpose. These polymers are generally manufactured from vinyl acetate polymers by saponification using methanol. After this saponification, a polymer solution or a polymer gel is generally obtained, and is then treated by means of suitable processes to make polymer particles therefrom. In practice, and especially in the particular case of EVOH (hydrolysed ethylene-vinyl acetate copolymer), it is preferred to avoid the formation of gels since they complicate the processes used for making granules or other particles therefrom that are suitable for the standard implementation processes (extrusion, coating, etc.).

Thus, patent application EP 1 179 547 discloses a method for treating alcoholic EVOH solutions that avoids the formation of gels and that consists in replacing some of the alcohol with water in a suitable device. A solution of EVOH in a water/alcohol mixture is thus obtained, which is easier to process by drawing (extrusion of draw rods in a bath containing a water/alcohol mixture). This last step of the process nevertheless remains problematic (the composition of the bath needs to be kept constant) and the product obtained requires a long drying time. In addition, this process involves large amounts of liquid, which generally need to be regenerated.

The Applicant consequently attempted a simple recovery of the EVOH in solution in water/ethanol mixtures by azeotropic distillation of the said EVOH (as described in patent application EP 945 481 in the name of Solvay). However, even working under vacuum, the system sets to a solid. Recovery of the polymer by atomization (as described in the pending patent application FR 0 116 070 in the name of Solvay) has not gone any further towards solving the problem, a polymer crust being obtained rather than particles of uniform granulometry.

The aim of the present invention is consequently to provide a process for recovering a vinyl alcohol polymer in solution, which is quick and simple, but nevertheless makes it possible to obtain particles with a granulometry suitable for the standard implementation processes.

To this end, the present invention relates to a process for recovering a vinyl alcohol polymer in solution in a solvent, according to which:
(a) the polymer solution is converted into a gel
(b) water is added to the gel obtained
(c) mechanical rupture of the gel is performed to form polymer particles in suspension in a liquid comprising the solvent and water
(d) the polymer particles are collected.

The vinyl alcohol polymer whose recovery is targeted by the process according to the present invention is, by definition, a polymer containing monomer units of vinyl alcohol type. It is generally a case of (co)polymers obtained by partial or even virtually total hydrolysis (saponification) of polymers containing monomer units of vinyl acetate type. These polymers (and the hydrolysed homologues thereof) either may consist solely of vinyl alcohol and/or vinyl acetate monomers (in the case of polyvinyl alcohols (PVA) per se or partially hydrolysed polyvinyl acetates (PVAc)) or may comprise another monomer, for instance ethylene. A full description of these polymers, their properties and methods for obtaining them is given especially in Kirk-Othmer Encyclopedia of Chemical Technology, John Wiley & Sons, in the respective chapters “Vinyl Acetate Polymers” and “Vinyl Alcohol Polymers”. It is generally preferable for the polymer not to contain too many -OH groups, otherwise it becomes water-soluble and the process according to the present invention then becomes more difficult to apply. The process according to the present invention gave good results in the particular case of EVOH resins. In this case, the ethylene content is preferably greater than or equal to 20% or even 25% in order for the polymer not to be water-soluble. In particular, the process according to the invention gives good results with commercially available resins having an ethylene content ranging from 27 to 44 mol %. The process according to the present invention also applies to polymer mixtures as described above (PVA, PVAc at least partially hydrolysed, EVOH) in solution.

The solvent in which the vinyl alcohol polymer is dissolved is generally a liquid with a solubility parameter (a definition and experimental values of which are given in “Properties of Polymers”, D. W. Van Krevelen, 1990 edition, pp. 200-202, and also in “Polymer Handbook”, J. Brandrup and E. H. Immergut, John Wiley & Sons Editors, Second Edition, p. IV-337 to IV-359) in the region of the solubility parameter of the polymer and/or that contains functions capable of creating hydrogen bonds with the alcohol functions of the polymer (mainly alcohols: see “Polymer Handbook”, J. Brandrup and E. H. Immergut, J. Wiley & Sons Editors, Fourth Edition, p. VII-683, Table 1: Strongly hydrogen bonded solvents). It is understood that the term “solvent” means either a simple substance or a mixture of substances. The solvent preferably comprises an alcohol and in particular an alcohol with a solubility parameter in the region of 20 (methanol, ethanol, propanol, etc.). In particular, ethanol gives good results, even more particularly when the polymer is EVOH. Water/alcohol mixtures are generally preferred, in particular with alcohols with a solubility parameter in the region of 20. The water/ethanol mixture often gives good results (especially in the case of EVOH) and is often used especially for reasons of toxicity. The dissolution of EVOH in a water/ethanol mixture having an ethanol content of from 30% to 70% by weight gives good results; however, it is faster for an ethanol content of about 50% to 60%.

The process according to the present invention advantageously applies to a vinyl alcohol polymer solution heated above room temperature, for example to 60° C. At this temperature, the concentration may be greater than or equal to 5% by weight (relative to the total weight of the solution) or even 10%. However, it will advantageously not exceed 30% or even 20% by weight.

In the process according to the present invention, the polymer solution is converted into a gel, i.e. into an elastic solid in which the polymer molecules constitute a network with interlinking points. In contrast with the case of crosslinked polymers, these interlinking points are bonds of physical rather than chemical origin, and are therefore simply regions with a higher concentration of polymer. The formation of a gel, which is likened to a crystallization phenomenon (and thus includes a germination step and a growth step), may be induced by reducing the temperature and/or by adding a non-solvent. A temperature reduction gives good results. However, in general, it will be avoided to go below 0C since the gels obtained are then too elastic to be broken mechanically. The addition of a seeding agent to the solution before or during the formation of the gel makes it possible to increase its rate of formation and also makes it possible to avoid excessive cooling, which is often undesired for economical reasons. Examples of seeding agents that may be mentioned include polymer powder (for example of the same nature as that to be recovered), precipitated calcium carbonate, etc. A person skilled in the art will take care to optimize the gel setting temperature and the type of germination (seeding) to obtain the desired grain morphology and process duration.

In the process according to the invention, during step (b), water is added to the gel obtained. During step (c), it is then broken mechanically, i.e. converted into a suspension of polymer particles by any means and/or any suitable device, such as a mill or a stirrer. In particular, the use of a stirrer of suitable morphology stirring at a suitable speed (these factors may be readily determined by a person skilled in the art) gives good results.

After step (c), the mixture is in the form of a dispersion of polymer particles in a liquid comprising the solvent and water. The polymer particles may then be separated from this mixture by any suitable means (evaporation, centrifugation, etc.). However, in order to collect solvent-free polymer particles, a distillation (preferably an azeotropic distillation) of the water/solvent mixture may be performed, when this is possible, until the mixture is substantially free of solvent. Such a method is suitable in the case of water/alcohol mixtures, and in particular in the case of the water/ethanol mixture. Consequently, according to an advantageous variant of the process according to the invention, after step (c), the liquid is a water/alcohol mixture from which the alcohol is removed by azeotropic distillation. In order to limit the thermal degradation and/or the setting to a solid of the polymer, care will be taken in certain cases (for example as with EVOH) to perform this distillation under vacuum (i.e. at a pressure below atmospheric pressure, or even less than or equal to 300 mbar) in order to be able to reduce its temperature. In the case of EVOH, setting to a solid is especially observed at and above 67° C.; thus, in practice, care will be taken to ensure that the temperature is less than or equal to 65° C. As regards the pressure, it will advantageously be less than or equal to 250 mbar. EVOH particles suspended in water are thus collected. These particles and the water may then be separated by any suitable means (centrifugation and/or drying, etc.). Alternatively, the dispersion may be used in its existing form, for example in coating applications.

During the abovementioned azeotropic distillation, the process is preferably performed with stirring and at a shear rate adapted to the desired grain size. The reason for this is that the Applicant has found that working with stirring makes it possible to reduce the grain size, quite probably by inhibiting aggregation between primary particles.

The process according to the present invention may be incorporated into any process involving the recovery of a vinyl alcohol polymer from a solution. In particular, it may form part of a process for the recycling of such polymers.

Thus, according to one preferred variant, the process according to the present invention is applied to a polymer solution obtained by shredding at least one article comprising at least one vinyl alcohol polymer (such as EVOH) into fragments with a mean size of from 1 cm to 50 cm in the case where it exceeds these sizes, and by placing the article fragments in contact with a solvent capable of dissolving the polymer but not the other possible constituents of the article. A water/alcohol mixture, and in particular a water/ethanol mixture, gives good results. According to this variant of the invention, the polymer solution is first, if necessary, freed of these other constituents (for example by means of filtration) before being converted into a gel.

Such a recycling process may be continuous or discontinuous (batchwise). It is preferably continuous.

One important advantage of the process according to this variant of the invention is that it can in most cases operate in a closed loop, without generating waste. Specifically, the water/solvent mixture collected during the recovery of the polymer particles may be recycled into the polymer dissolution step and/or the gel breaking step by means of optimizing the flows.

An advantageous case to which the process according to the invention may be applied is that of the recycling of fuel tanks made of HDPE (high-density polyethylene) with an EVOH layer, and more particularly of waste derived from the manufacture of such fuel tanks by coextrusion blow-moulding. Specifically, this waste (or “flash”) is currently reused in its existing form in one of the layers of the tank or is subjected to a pretreatment by triboelectricity, by means of removing the EVOH-rich fraction. However, this fraction contains about 25% EVOH, which it would be advantageous to be able to recover for obvious economical reasons. This recovery may be performed by using the process described above, i.e. by performing the selective dissolution of the EVOH and by treating this solution via the process described above. Consequently, according to one particularly advantageous variant, the process according to the present invention relates to a process for the recycling of fuel tank waste comprising HDPE and EVOH, according to which:
(a) the waste is subjected to a triboelectric treatment to obtain an EVOH-poor fraction and a fraction richer in EVOH
(b) the two fractions obtained in step (a) are separated
(c) (c) the EVOH-rich fraction is placed in contact with a water/ethanol mixture and the EVOH is at least partially dissolved in this mixture
(d) the solution is filtered to remove the HDPE and possibly the EVOH and the other undissolved constituents therefrom
(e) the solution is converted into a gel
(f) water is added to the gel obtained
(g) the gel is broken mechanically to form EVOH particles suspended in a water/ethanol mixture
(h) the ethanol is evaporated off by azeotropic distillation under vacuum to give a suspension of EVOH particles in water
(i) the EVOH particles are collected.

Certain advantageous variants described above will preferably be applied in this process. Thus, care may be taken to ensure that the solvent used is an ethanol/water mixture with an ethanol content of from 30% to 70% by weight. It is also possible, during step (h), to perform the azeotropic distillation at 65° C. and at 250 mbar. Finally, during step (i), the suspension of EVOH in water may be subjected to a centrifugation followed by drying.

The process according to the present invention makes it possible to obtain a very fine and uniform powder formed from vinyl alcohol polymer particles. In order to characterize the granulometry (i.e. the particle size distribution) of the powder obtained and to demonstrate the uniformity of the form of the particles, the particle size is expressed by the “equivalent diameter” that a theoretical sphere behaving in the same manner as the particle under consideration would have. This is referred to as an “equivalent sphere”. The equivalent diameter distribution of these spheres is adjusted on the basis of theoretical laws (for example the normal or Gaussian distribution law). The fineness is characterized by a positional parameter (for example the median diameter or mean diameter) and the granulometric heterogeneity by a dispersion parameter (for example the “span” or standard deviation).

The span is defined from the equivalent diameter distribution curve, as

$$span = \frac{D ( 0.9 ) - D ( 0.1 )}{ D ( 0.5 )}$$

in which D(0.9)=diameter of the sample for which 90% of the sample is below this diameter
D(0.1)=diameter of the sample for which 10% of the sample is below this diameter
D(0.5)=diameter corresponding to the distribution median.

The numerator in the span expression is known as the “interpercentile interval”. This parameter may also be used to characterize the dispersion of the equivalent diameter distribution.

According to the invention, the largest dimension of the particles obtained is less than or equal to 100 μm and preferably less than or equal to 70 μm. However, this dimension is generally greater than or equal to 1 μm or even 5 μm. The term “largest dimension” is intended to denote the length in the case of filamentous or oblong particles, and the widest diameter in the case of substantially spherical particles. As explained previously, the particle size may be influenced by the presence of stirring during the step of evaporation (azeotropic distillation) of the solvent.

The process described above makes it possible to obtain particles with an equivalent diameter preferably of less than or equal to 100 μm and in particular less than or equal to 70 μm.

Generally, the polymer particles obtained via the process described above also have a narrow particle size dispersion. Preferably, the span is less than 5 and even more preferably less than 3.

Such particles may be used in the existing form in certain applications such as coating. Alternatively, these particles may be granulated in an extruder or, more advantageously, sintered so as to avoid thermal ageing of the polymer.

The invention also relates to a multilayer fuel tank comprising in the barrier layer the EVOH obtained via the process described above.

The present invention is illustrated in a non-limiting manner by the examples and counterexamples that follow.

### EXAMPLE 1

Fuel tank production waste containing about 25% by weight of EVOH (Eval® F 101A) and 75% by weight of HDPE (Eltex® RSB 714 from Solvay) was placed in contact with a 70/30 by weight ethanol/water mixture at 60° C. until a solution containing about 10% by weight of EVOH was obtained, i.e. for 45 minutes. This solution was cooled to 5° C. for 90 minutes to bring about the formation of a gel. 120 g of water were added to this gel, which was then broken mechanically using a counter-paddle stirrer stirring at a speed of 300 rpm. The particle suspension obtained was brought to 60° C. and evaporated under 250 mbar until evaporation of the ethanol was complete, to leave a suspension of EVOH particles in water. This suspension was centrifuged and the substantially spherical particles collected were dried in an oven for 24 hours under vacuum, at 60° C. The span measured for the particle size distribution was 1.45, corresponding to a median diameter of 53 μm and an interpercentile interval of 77 μm.

### EXAMPLE 2

Example 1 was repeated, but changing the ethanol evaporation conditions: this was performed at 55° C., under 150 mbar and with a stirrer stirring speed of 900 rpm. Particles (lumps) were then obtained and were subjected to the action of ultrasound. Before applying the ultrasound, the first distribution corresponded to a span of 2.64 (median diameter=15.07 μm; interpercentile interval=39.75 μm). After applying the ultrasound, the second distribution corresponded to a span of 1.97 (median diameter=5.29 μm; interpercentile interval=10.43 μm). A reduction in the particle size dispersion is observed.

### COMPARATIVE EXAMPLE 3

A solution of EVOH in an ethanol/water mixture was obtained as in Example 1. However, it was subjected directly to evaporation of the ethanol instead of converting it into a gel as previously. Setting of the solution to a solid was gradually observed as the ethanol evaporated off, to form a block of EVOH full of solvent.

### COMPARATIVE EXAMPLE 4

A solution containing 5% EVOH (in a 70/30 ethanol/water mixture) was obtained according to a route identical to that of Example 1 and was subjected to atomization at a temperature of about 65° C. and under a pressure of about 250 mbar. To do this, the hot solution was injected via an atomizer into the top of an atomization chamber and steam was injected into the bottom. A crust of tacky EVOH was collected. Various lower pressures and temperatures were tested, and also various steam flow rates, solvent compositions and EVOH concentrations, without any significant influence on the morphology of the EVOH collected.

### COMPARATIVE EXAMPLE 5

A solution containing 30% EVOH (in a 70/30 ethanol/water mixture) was obtained according to a route identical to that of Example 1 and was subjected to drawing in a bath containing water and brought to a temperature of 4° C. A thread 2.5 mm in diameter was obtained, which was too elastic to be granulated. It was thus subjected to drying (for 24 hours at 60° C. under vacuum), but then became too brittle to be granulated.

1. Process for recovering at least one vinyl alcohol polymer in solution in a solvent, according to which:
(a) the solution is converted into a gel
(b) water is added to the gel obtained
(c) the gel is broken mechanically to form polymer particles in suspension in a liquid comprising the solvent and water.

2. Process according to claim 1, in which the solvent is a water/alcohol mixture.

3. Process according to claim 2, in which the polymer is EVOH and the alcohol is ethanol.

4. Process according to claim 1, in which the formation of the gel is induced by a temperature reduction.

5. Process according to claim 1, in which a seeding agent is added to the solution before or during the formation of the gel.

6. Process according to claim 1, in which, after step (c), the liquid is a water/alcohol mixture from which the alcohol is removed by azeotropic distillation.

7. Process according to claim 6, in which the azeotropic distillation is performed with stirring.

8. Process according to claim 1, applied to a polymer solution obtained by shredding at least one article comprising at least one vinyl alcohol polymer into fragments with a mean size of from 1 cm to 50 cm in the case where it exceeds these sizes, and by placing the article fragments in contact with a solvent capable of dissolving the polymer but not the other possible constituents of the article.

9. Process according to claim 8, applied to the recycling of fuel tank waste comprising HDPE and EVOH, according to which:
(a) the waste is subjected to a triboelectric treatment to obtain an EVOH-poor fraction and a fraction richer in EVOH,
(b) the two fractions obtained in step (a) are separated.
(c) the EVOH-rich fraction is placed in contact with a water/ethanol mixture and the EVOH is at least partially dissolved in this mixture,
(d) the solution is filtered to remove the HDPE and possibly the EVOH and the other undissolved constituents therefrom,
(e) the solution is converted into a gel,
(f) water is added to the gel obtained,
(g) the gel is broken mechanically to form EVOH particles suspended in a water/ethanol mixture,
(h) the ethanol is evaporated off by azeotropic distillation under vacuum to give a suspension of EVOH particles in water and
(i) the EVOH particles are collected.

10. Particles of vinyl alcohol polymer that may be obtained via the process according to claim 1, and the largest dimension of which is less than or equal to 100 μm.

11. Particles according to claim 10, with a span of less than 3.

12. Particles of vinyl alcohol polymer that may be obtained via the process according to claim 1, and the equivalent diameter of which is less than or equal to 100 μm.

13. Multilayer fuel tank comprising in the barrier layer the EVOH of the process described according to claim 1.
